(19) United States
(12) Patent Application Publication
(10) Pub. No.: US 2007/0018033 A1
(43) Pub. Date: Jan. 25, 2007

(54) Precision aerial delivery of payloads

(76) Inventors: Jerome P. Fanucci, Lexington, MA (US); Nathan Gravelle, Amesbury, MA (US); David Maass, Guilford, CT (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/386,465

(22) Filed: Mar. 22, 2006

Related U.S. Application Data
(60) Provisional application No. 60/663,971, filed on Mar. 22, 2005.

(51) Int. Cl. F42B 10/00; B64C 3/56

(52) U.S. Cl. 244/3.27; 244/49

(57) ABSTRACT

An aerial deliver system mounts a payload to an air delivery vehicle for aerial deployment by air into water from a location remote from the target region. The air delivery vehicle includes deployable wings and tail fins for gliding or powered flight to a target region. A release mechanism between the air delivery vehicle and the payload provides a clean separation between the two.

### CROSS REFERENCE TO RELATED APPLICATIONS

This application claims the benefit under 35 U.S.C. §119(e) of U.S. Provisional Application No. 60/663,971, filed on Mar. 22, 2005, the disclosure of which is incorporated by reference herein.

### STATEMENT REGARDING FEDERALLY SPONSORED RESEARCH OR DEVELOPMENT

This invention was made under Navy SBIR Contract Nos. N68335-04-C-0132 and N68335-05-C-0422. The Government has certain rights in this invention.

### BACKGROUND OF THE INVENTION

A sonobuoy is an electronic sensor dropped into the ocean. These sensors detect and amplify sound signals from underwater objects and transmit the signal data by radio. A typical sonobuoy may comprise many different elements packaged into a small cylindrical canister. For example, a canister may be about 5 inches in diameter and 3 feet long. Sonobuoys are used, for example, in anti-submarine warfare.

Some sonobuoys are deployed by dropping from an aircraft from altitudes as low as 175 feet and as high as 30,000 feet, at up to 370 knots indicated airspeed (KIAS). A small parachute deploys upon ejection of the sonobuoy from the dispenser tube in the aircraft. The parachute ensures that the sonobuoy enters the water close to normal at a suitable velocity (approximately 100 to 120 KIAS). The precise location of the sonobuoy typically must be marked in an overflight by an airplane.

### SUMMARY OF THE INVENTION

The present invention relates to a system for remote or stand-off aerial deployment of a sonobuoy or other payload, such that the payload can be deployed by air into the water from a location far from the target region. The present system can deploy a payload from more than 36 nm from the target region. The delivery system includes a payload releasably mounted to an air delivery vehicle. Upon launch from an aircraft, wings and tail fins of the air delivery vehicle deploy, and the aerial delivery system becomes an unpowered glide vehicle. When it reaches the target area, the payload is jettisoned and separates cleanly from the air delivery vehicle for entry into the water. The delivery mechanism of the present invention is precise, so that sensor location can be determined accurately without the need for an overflight to mark the location of the sonobuoy or other payload.

### DESCRIPTION OF THE DRAWINGS

The invention will be more fully understood from the following detailed description taken in conjunction with the accompanying drawings in which:

FIG. 1 is an isometric view of an aerial delivery system deployed in flight;

FIG. 2 is an isometric view of the aerial delivery system of FIG. 1 in a stowed configuration;

FIG. 3 is a schematic illustration of the operation of the aerial delivery system;

FIG. 4 is an exploded isometric view of a fuselage of an air delivery vehicle of the aerial delivery system;

FIG. 5A is an isometric view of the wings and tail fins of the air delivery vehicle in a stowed position;

FIG. 5B is an isometric view of the wings and tail fins of the air delivery vehicle in a deployed position;

FIG. 6A is a plan view of a wing deployment mechanism with the wings in a stowed position;

FIG. 6B is a plan view of the wing deployment mechanism with the wings in a deployed position;

FIG. 6C is a plan view of a pawl assembly of the wing deployment mechanism in a stowed position;

FIG. 6D is a plan view of the pawl assembly is a partially deployed position;

FIG. 6E is a plan view of the pawl assembly locking the wing in the fully deployed position;

FIG. 7 is a perspective view of three lattice tail fins in the deployed position;

FIG. 8A is a perspective view of a deployment mechanism for a tail fin;

FIG. 8B is a further perspective view of the deployment and control mechanism of FIG. 9A;

FIG. 8C is an isometric view of a fin base of the deployment mechanism for a tail fin;

FIG. 8D is a bottom isometric view of the fin base of FIG. 8C;

FIG. 8E is an exploded isometric view of the deployment mechanism for a tail fin;

FIG. 8F is a isometric view of the locking mechanism of the tail fin;

FIG. 8G is an isometric view of the locking mechanism of the tail fin;

FIG. 9A is an isometric view illustrating servo motor locations for the tail fins;

FIG. 9B is an isometric view illustrating a further servo motor location of a tail fin;

FIG. 10A is a schematic view of the ADV and payload in flight before separation;

FIG. 10B is a schematic view of the ADV and payload upon separation;

FIG. 10C is a schematic view of the payload with parachute deployed;

FIG. 11 is a schematic view of a further separation embodiment; and

FIG. 12 is an isometric view of a dynamic pressure probe for an air delivery vehicle according to the present invention.

### DETAILED DESCRIPTION OF THE INVENTION

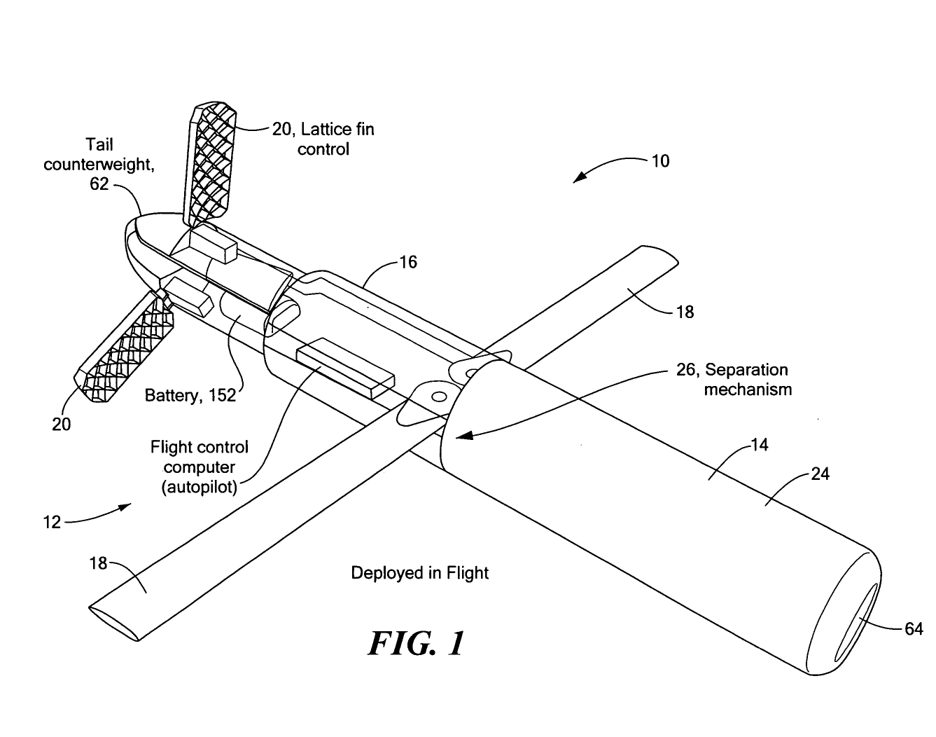

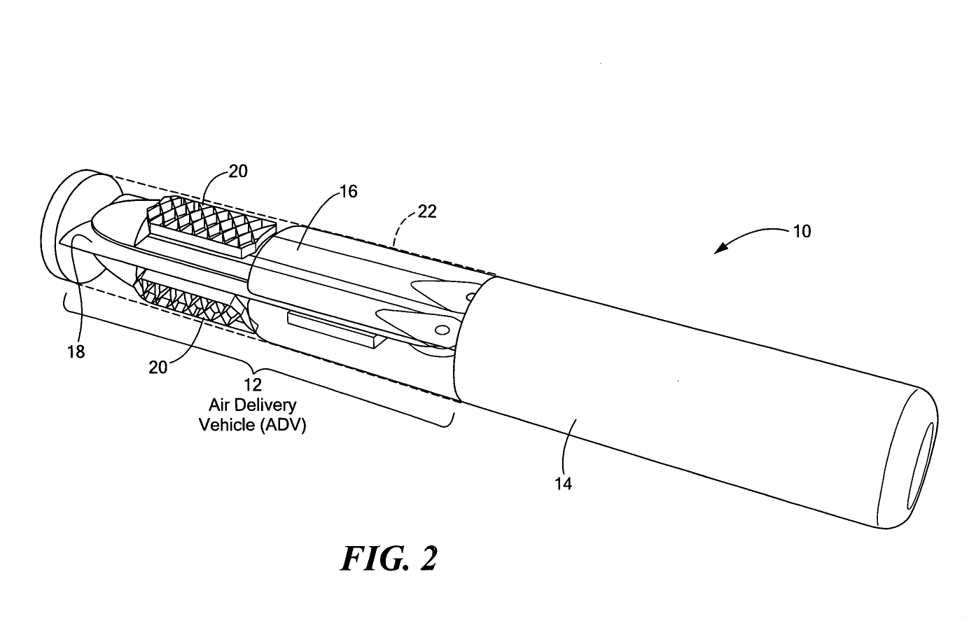

Referring to FIGS. 1 and 2, an aerial delivery system 10 of the present invention includes an air delivery vehicle (ADV) 12 and a payload 14. The ADV comprises a fuselage 16 to which deployable wings 18 and tail fins 20 are attached. In the stowed configuration (FIG. 2), the wings and tail fins are folded against the fuselage and packaged within a cylindrical sleeve 22, and the payload is contained within a forward cylindrical housing or shell 24. The aerial delivery system includes a release mechanism 26 for attachment of the payload to and jettison from the ADV. The air delivery system can be launched from existing launch tubes on aircraft that are used, for example, to launch sonobuoys. Upon deployment, the cylindrical sleeve 22 is pulled off the ADV 12, and the deployable wings 18 and tail fins 20 open out. The aerial delivery system becomes an unpowered glide vehicle. Upon reaching the target region, the payload separates from the ADV.

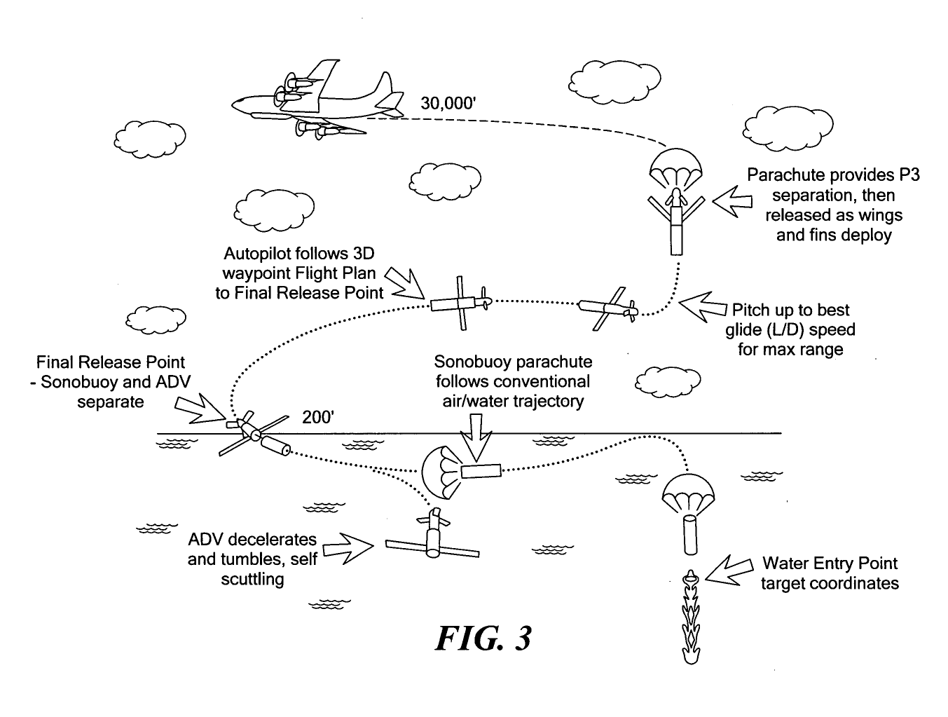

FIG. 3 illustrates more particularly operation of the aerial delivery system configured for deployment of a sonobuoy payload. Initially, a flight plan (waypoints) is downloaded to an autopilot within the aerial delivery system via a suitable port or remotely via IR or other wireless connection. The flight plan can be programmed to fly around obstacles or to approach the target region from a direction that masks the actual launch point.

The aerial delivery system is loaded into the launch tube in the aircraft and readied for launch. The delivery system is loaded with the wings oriented horizontally so that upon launch the delivery system can acquire a level attitude as quickly as possible to minimize altitude loss. The aerial delivery system can be air launched 36 nm or more from the water entry location at 30,000 feet and up to 240 knots indicated air speed (KIAS).

The delivery system can be launched in any suitable manner, for example, using a cartridge actuated device (CAD) explosive charge to cause severance of a launch container breakout cap as is known from prior art sonobuoy deployment. Shortly after exiting the launch tube, a parachute opens, for example, in a manner known in the art, and orients the delivery system relative to the local airflow during descent. After a few seconds, the delivery system is aligned with the airflow and descending at a velocity well above the minimum controllable airspeed. At this point, the parachute is severed from the ADV in any suitable manner, such as with burn-through resistors (not shown). Release of the parachute pulls the sleeve off the ADV and releases the spring-loaded deployable wing and tail surfaces.

The autopilot is programmed to seek and maintain vehicle airspeed to reach the target. At maximum range to the target, the autopilot controls the vehicle to attain the best lift-to-drag (L/D) ratio. The glide range for any aircraft is maximized at the best L/D. For example, in one embodiment for deploying a sonobuoy, best L/D for the delivery system is 7.4, resulting in a glide angle of 7.7°. Assuming a 500 foot altitude loss during wing and tail fin deployment and stabilization, this results in a glide range of 36 nm from 29,500 feet with no wind. The delivery system can achieve a 28 nm stand-off range with a 40 knot direct headwind. The speed for best L/D varies with altitude, and this is programmed into the autopilot. At 29,500 feet, best glide speed is 225 knots, and the minimum descent rate is 51 feet per second (fps). At sea level, best glide speed is 138 knots, and the descent rate is 32 fps. Overall, the descent duration from initial deployment at 30,000 feet to water entry is about 12 minutes.

Referring again to FIG. 3, the delivery system navigates to a release point, where the payload and the ADV separate. The release point is typically 200 feet over the water's surface, and is located a short distance from the targeted water entry point, where the sonobuoy will operate. This distance and direction account for the ballistic trajectory of the sonobuoy once it has been released from the delivery system.

At the release point, a sonobuoy release mechanism, described further below, is activated. A sonobuoy parachute opens, for example, in a manner known in the art, and starts the sonobuoy on a ballistic trajectory towards the water entry point.

Within milliseconds of sonobuoy separation, full deflection commands are issued to the control fins of the ADV to command it to a configuration that provides maximum separation between the ADV and the sonobuoy. With the large shift in the center of gravity of the ADV as a result of sonobuoy separation, the ADV is no longer statically stable. The separation maneuver commands the ADV to a very high angle of attack, causing it to rapidly decelerate. No longer controllable, the ADV tumbles into the sea and sinks to the bottom.

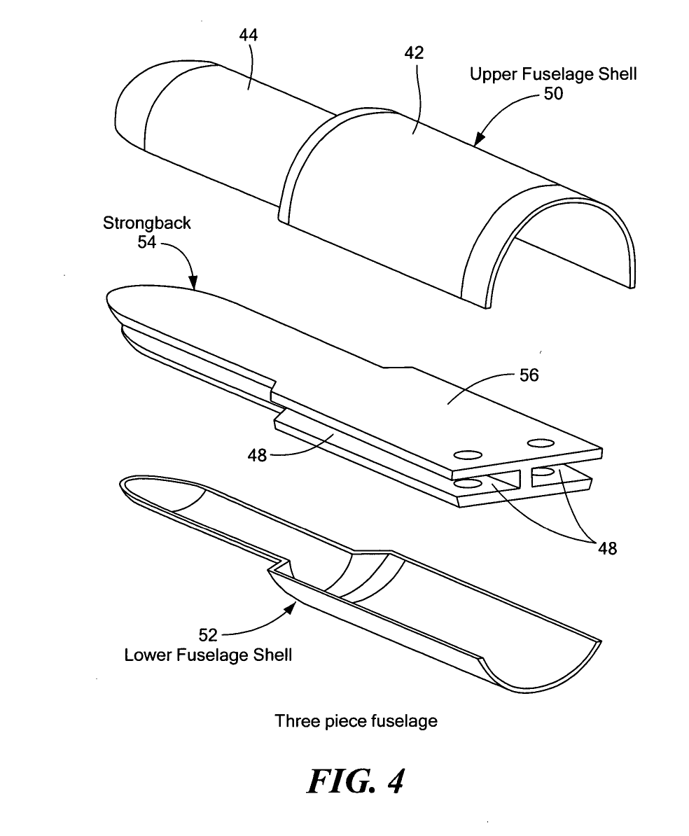

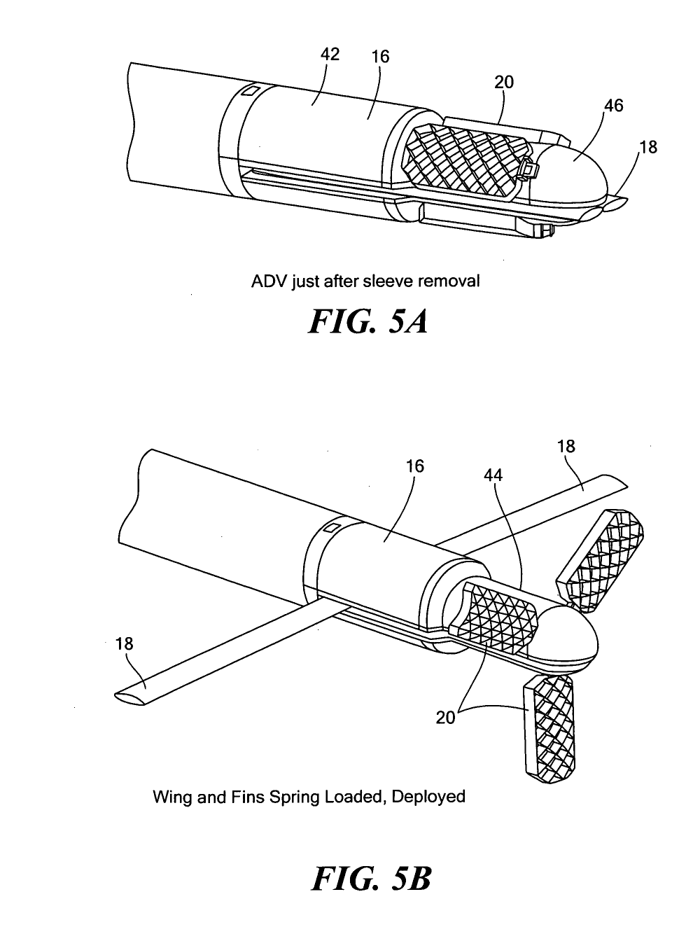

Referring now to FIGS. 4-5B, the components of the ADV are mounted to the fuselage 16. The fuselage also mounts the separation mechanism for the releasable payload. The fuselage has a generally cylindrical shape 42 at the payload attachment mechanism and over most of its length. It necks down in diameter in the tail region 44 to allow the lattice fins to fold flat against the fuselage without exceeding the fuselage diameter envelope. The fuselage then fairs into a streamlined tailcone form 46. The wings are mounted at roughly the centerline of the fuselage, to allow the maximum wing chord to be stored in axial slots 48 in the fuselage body, from which the wings are deployed laterally. The fuselage can be formed in any suitable manner, from one or several parts, as desired for shape contour, weight, and cost to manufacture.

In one embodiment, illustrated in FIG. 4, the fuselage includes an upper shell 50, a lower shell 52, and a strongback 54. The wings are attached to the strongback at pivot points. The strongback includes slots 48 on each side into which the wings are stowed when in the closed position. The strongback also supplies a surface 56 on which the other components are affixed. The fuselage parts may suitably be comprised of a sandwich of graphite/epoxy laminates over a foam core. This structure provides high strength and stiffness while minimizing weight. Alternatively, the fuselage may be comprised of any other material whose strength and stiffness meet functional requirements under the applied loads.

The parachute assembly that is employed when the delivery system is first launched to stabilize the descent occupies the volume between the tail cone 46 and the launch container breakout cap. The parachute is sized and selected based on rapid deceleration and orientation of the vehicle prior to deployment of the wings and tail fins and minimum storage volume when packed.

For pitch stability, the center of gravity (CG) of the delivery system must be located slightly forward of the wing hinge points, which are located roughly at the quarter chord location of the wings. The weight of the payload contributes significantly to the forward location of the CG of the delivery system. The ADV components are packaged to obtain the desired CG location. The final CG location can be fine tuned with a counterweight 62 located in the tail cone of the ADV. The tail cone location has the highest moment arm, and therefore requires the smallest weight to obtain a given CG shift. Furthermore, the tail cone design weight can be readily adjusted without affecting other components and packaging.

The nose cone 64 on the payload is comprised of a compressible foam material. This material is a closed cell construction that is compressed in storage and expands when deployed. The nose material is selected to withstand the air loads that the flight will impart on the nose without deformation.

The wings 18 are formed from any suitable material whose strength and stiffness meet functional requirements under the applied loads, such as a composite material or a metal. Suitably, a composite material wing construction is a thin skin of graphite fibers embedded in epoxy resin matrix over a lower density foam core. The wing laminate thickness preferably increases from the lightly loaded wing tip to the more highly loaded wing root. Suitable composite wings having a constant chord can be formed by a pultrusion process. A twist distribution can be imparted to the pultruded composite wing to achieve improved aerodynamic performance by adjusting the lift distribution over the wing. The particular design can be determined by one of skill in the art. For example, the angle of incidence of the wings can be determined to provide the best L/D angle of attack to minimize fuselage form drag.

In one exemplary embodiment, each wing is about 16 inches long with a 2 inch chord. When fully deployed, these wings provide a wing area of 0.51 ft² with a very high aspect ratio of 18.5 as required for good glide performance. A suitable airfoil section preferably has low cruise drag characteristics in the Reynolds number and Mach number operating range, such as NACA 66-215.

In another embodiment, to maximize wing size, the wings can be stored within the fuselage in an overlapping or stacked configuration. One wing lies above the midplane of the fuselage and the opposite wing lies below the midplane. For example, wings having a 4 inch chord can lie within a fuselage diameter slightly larger than 4 inches, such as 5 inches. This effectively doubles the wing area over wings having a 2 inch chord. This configuration results in little actual asymmetry in lift and drag characteristics, and what small effects are present are outweighed by the increase in the effective wing area.

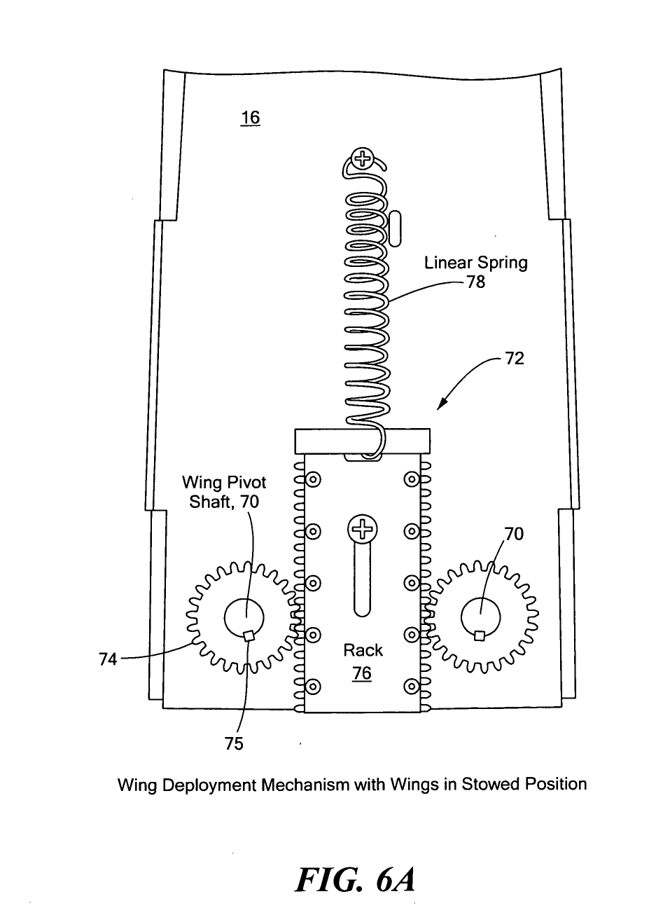

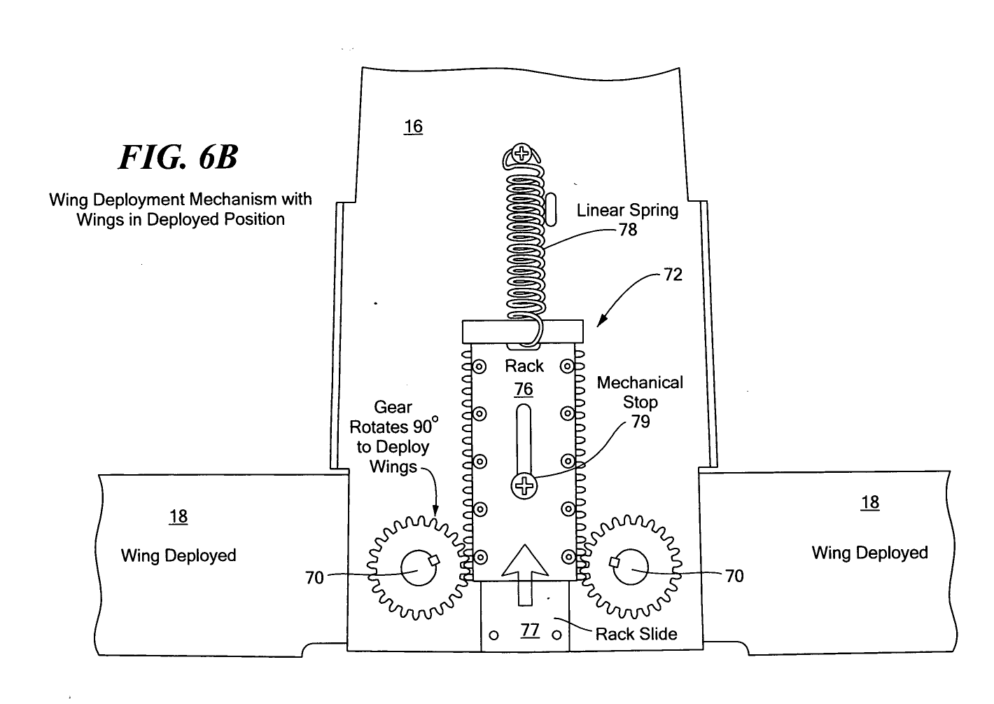

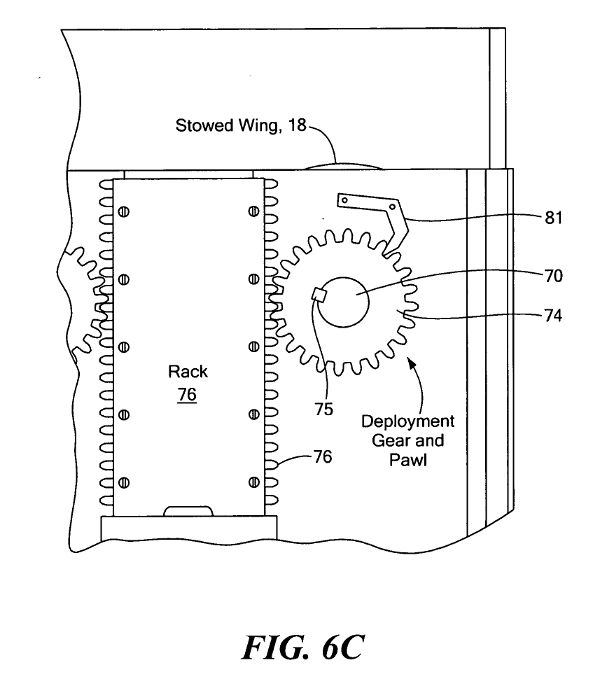

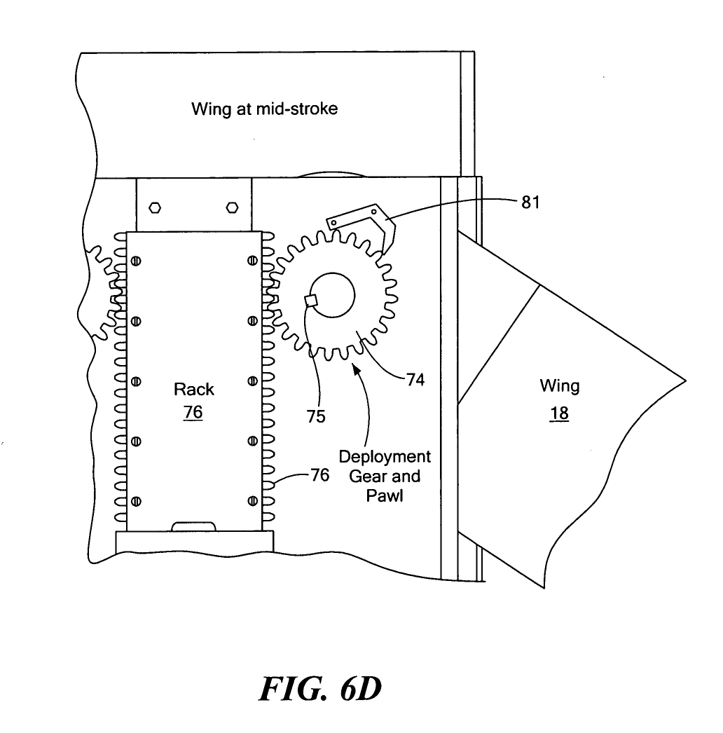

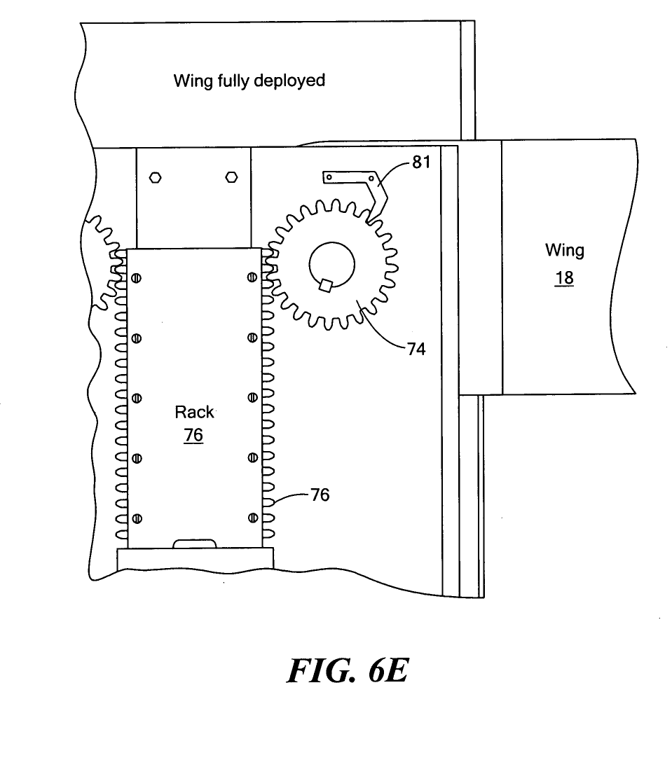

Referring to FIGS. 6A and 6B, the wings 18 are hinged to the fuselage 16 about pivot shafts 70 so that they can be stored against the ADV body prior to deployment. The wings swing out about 90° when deployed by, for example, a spring-loaded deployment mechanism 72. In this mechanism, a pinion gear 74 is keyed via key 75 to the lower end of the pivot pin of each wing. The pinion gear is mated to a sliding rack 76, such that an aft motion of the rack assembly on a slide 77 causes the wings to rotate forward 90° to their deployed position. The force and stored energy to deploy the wings against the airflow is provided by a linear spring 78. A stop 79 limits travel of the sliding rack. The applied torque to deploy the wings is designed by suitable selection of the pinion gear diameter, spring constant, and spring extension. This mechanism ensures that both wings deploy symmetrically. A positive locking mechanism, such as a pawl assembly 81, locks the wings in the fully open deployed position. See FIGS. 6C-6E.

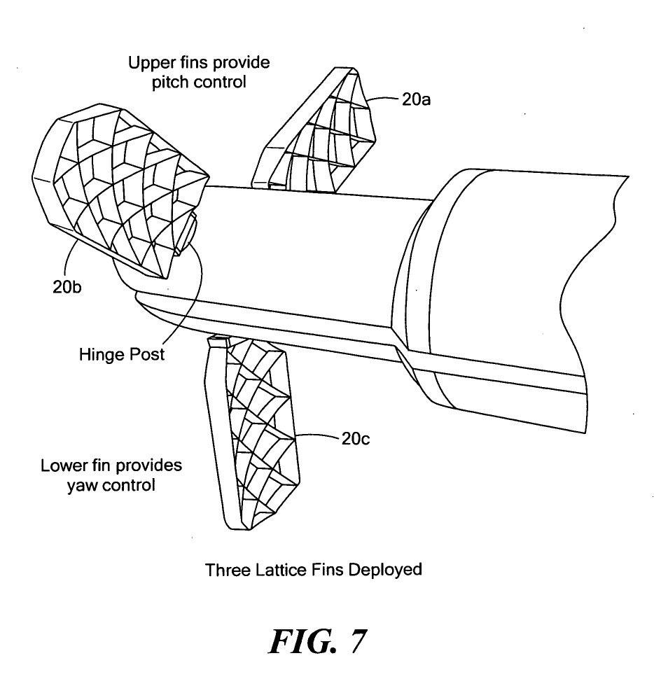

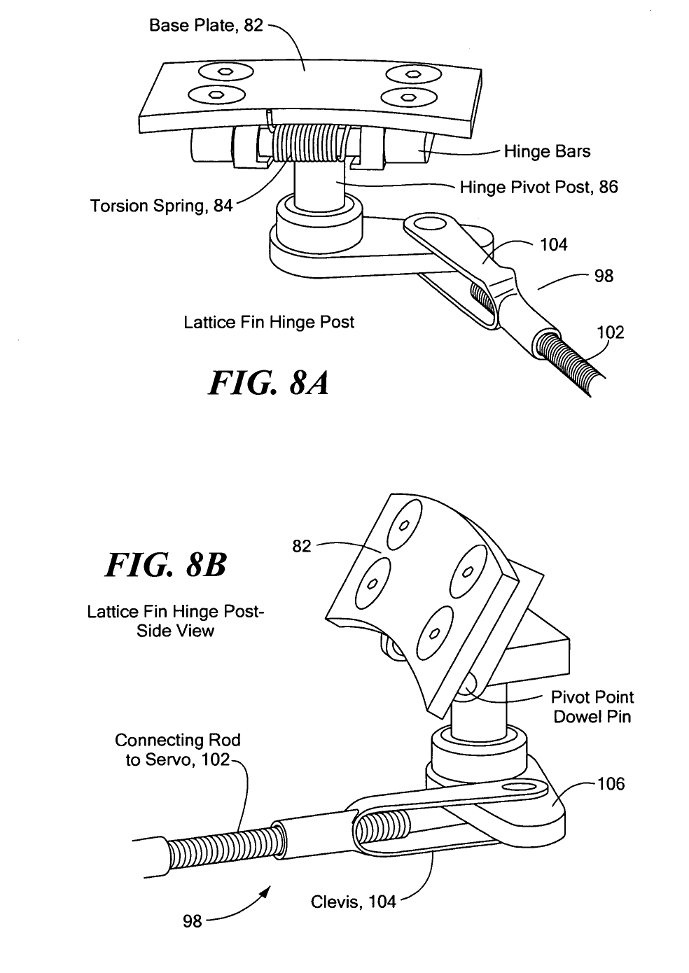

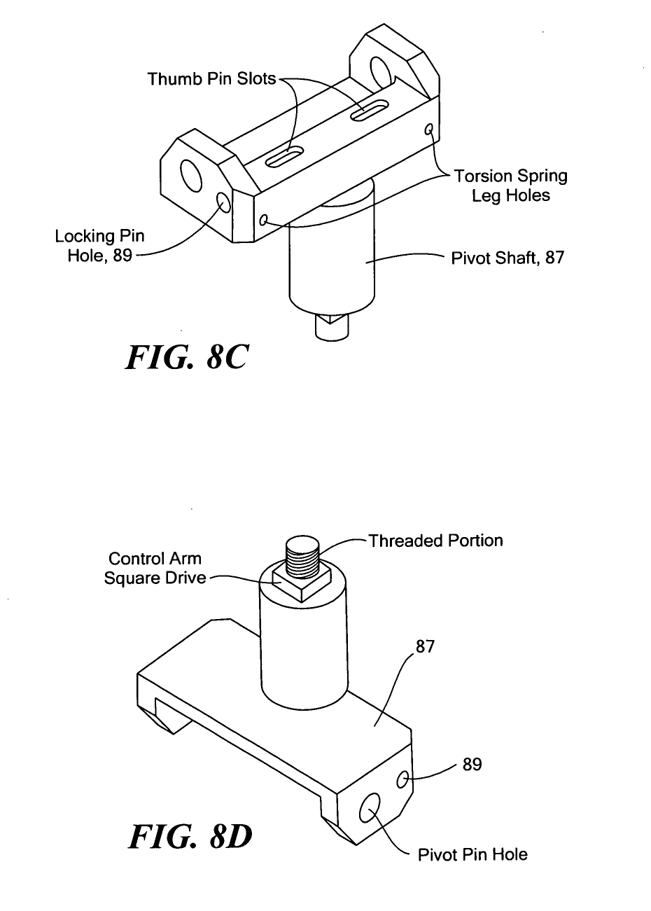

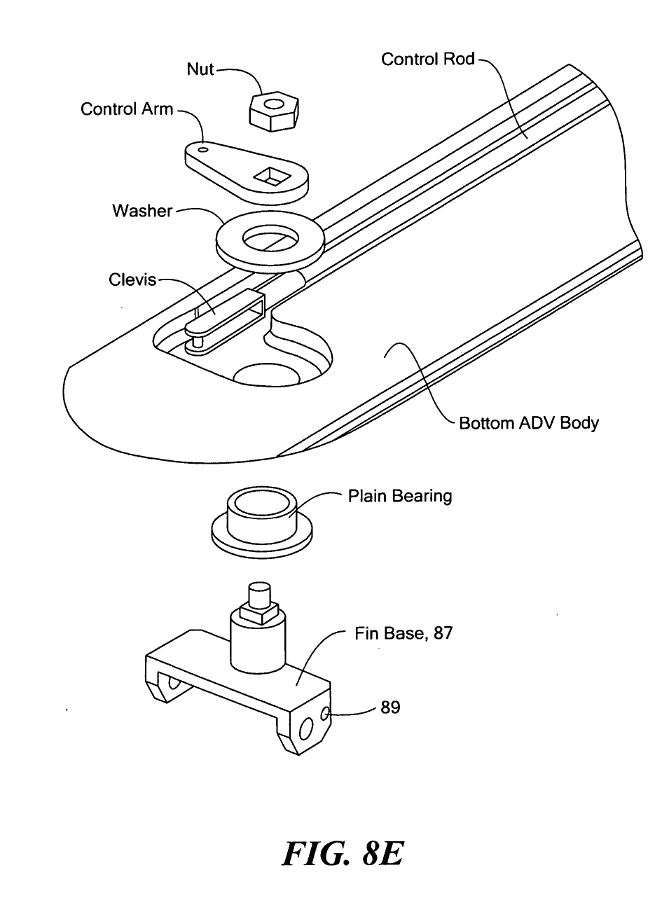

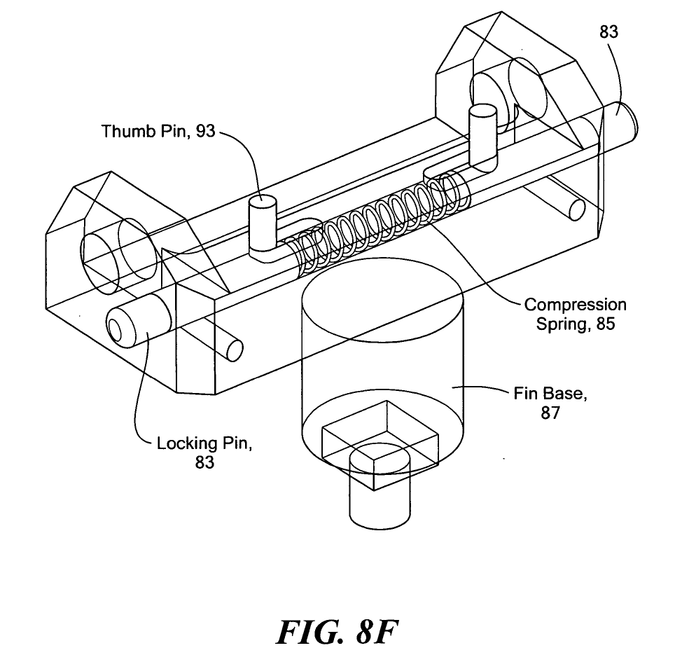

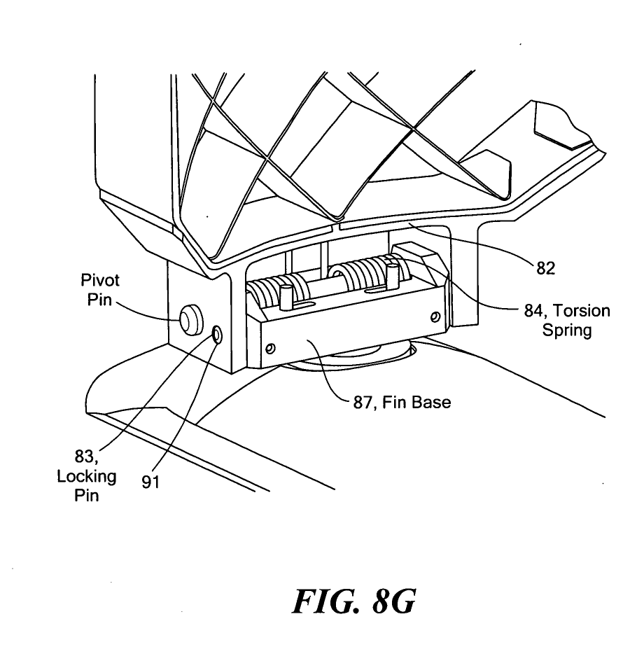

Three deployable tail control surfaces or fins 20a, 20b, 20c, are used on the delivery system. These fins are preferably lattice or grid fins. See U.S. Pat. No. 6,928,715. Such fins have an open lattice framework with webs at 45° to the edges of the fins. The rectangular planform of the fin is oriented normal to the airflow when the fin is deployed, such that air passes through the openings and past the fin surfaces. See FIG. 7. Drag of the lattice fins can be reduced by using very thin (e.g., 0.008 inch thick) webs, a thinner frame, and sharpening the leading and trailing edges. Each fin is mounted on a base plate 82. A torsion spring mechanism 84 is provided to deploy the fins once the sleeve is pulled off the ADV. See FIGS. 8A, 8B. The torsion spring rotates the base plate to the deployed position. When fully deployed, a small latching mechanism locks each fin in the deployed position. In the embodiment illustrated in FIGS. 8C-8G, the latching mechanism includes a pair of locking pins 83 that are biased outwardly by a compression spring 85 within a fin base 87. When the fin is rotated into the deployed position, holes 89, 91 on the fin base 87 and fin 82 align. The locking pins are biased into the holes 89, 91, thereby locking the fin in the deployed position. Thumb pins 93 can be used to remove the locking pins 83 from the holes 89 if necessary. An additional positive stop for travel of the fin may be provided if desired.

The fin deployment sequence is rapid, on the order of milliseconds. Thus, the inertial loads imposed on the lattice fin when it reaches the stops are considerable (500 to 1500 Gs). The inertia loads applied to the fin structure during the final portion of the deployment cycle can cause buckling stresses particularly at the root of the fin. Lattice fin gage can also be tailored to provide thicker material at the root, where the bending moments are highest, and thinner material at the tip to reduce fin drag in flight.

Once deployed, the fins can be controlled to alter the pitch, roll, and yaw of the delivery system during flight. For example, the base plate 82 is rotatable about an axis radiating from the fuselage. Referring to FIG. 7, the two lateral fins 20a, 20b act together to provide pitch control. The single dorsal fin 20c provides yaw control. All three fins, deflecting in the same direction, provide roll control as a result of the offset between the fin aerodynamic center and the delivery system central axis. A hinge mechanism on a pivot shaft 86 connected to a fin actuator (described further below) allows a range of fin motion of approximately ±20° about the pivot axis for flight control.

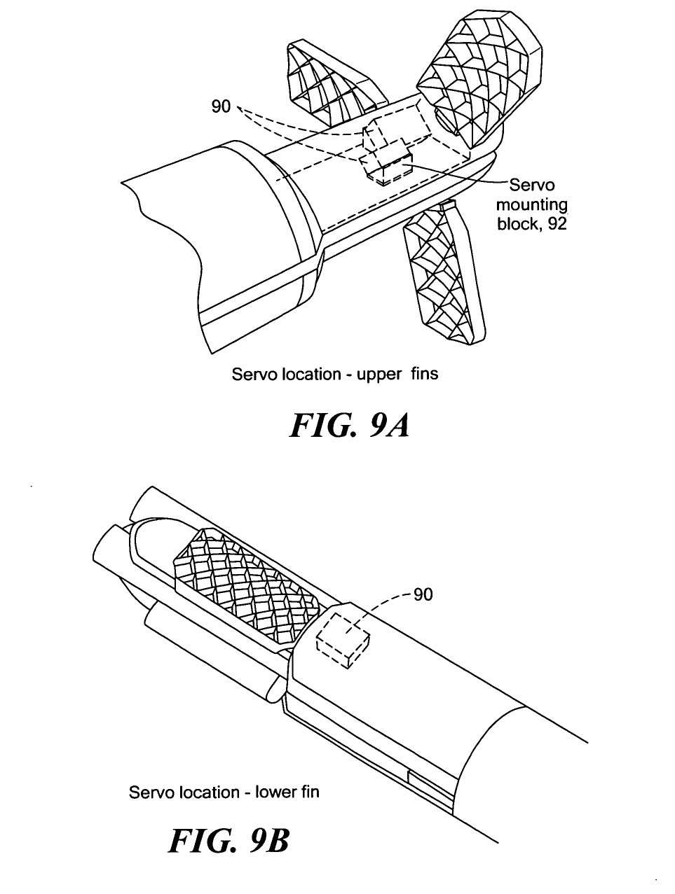

A servo motor 90 can be employed as the actuator for each fin. Each servo is oriented in alignment with the rotation axis of the respective fin axis using small mounting blocks 92 molded into the fuselage. This minimizes any nonlinear geometry associated with different linkage paths for each of the servos. Sufficient volume is available to locate the two upper servos (for the two upper control fins) in the necked down portion of the aft fuselage, just ahead of each fin. See FIG. 9A. The servo for the lower fin is located in the main body of the fuselage just ahead of the transition to the aft section. See FIG. 9B. This servo requires a longer linkage to the fin. The autopilot can be programmed to initially lock out control movements of the fins upon turning power on to prevent the servos from moving and possibly damaging the fins when they are in the stowed position.

The servos are selected based on torque, response time, and size. The pitching moment to actuate the lattice fins is typically an order of magnitude lower than the pitching moment required to deploy more conventional folding fins. Thus, smaller, lighter, and less costly actuators can be used. For example, in one embodiment, the maximum pitching moment required to actuate the fins at maximum operating speed (250 knots) is 6 in-lbs.

The servos are connected to the fins via a suitable linkage 98, such as a connecting rod 102 and clevis 104 attached to one end of a rotatable arm 106. The other end of the arm is fixed to and causes rotation of the hinge pivot post 86, thereby causing rotation of the associated fin about its axis radiating from the fuselage. See FIGS. 8A and B.

The length, width, and thickness of the fins can be selected based on stability, control authority, packaging and structural requirements. Layout of the three fins is selected based on control authority requirement in the pitch and yaw directions, while assuring clearance with the wings in the stored position and providing suitable volume for the three servos. The particular location of the fins along the length of the fuselage can be determined to optimize the fin moment arm, reduce drag, and minimize fin size. All of these components reside in the tail region of the delivery system.

For a given length delivery system, a smaller payload occupies less space at the front of the delivery system, allowing the fins to have a longer moment arm. This in turn allows the fins to be smaller, while still providing the same stability and control. Smaller fins also result in reduced drag and improved glide range. A longer body also permits storage of longer wings, which in turn extends the total wing span, again resulting in less induced drag and improved range. Also, the longer moment arm of the counterweight and the shorter moment arm of the payload allows the counterweight mass (and total delivery system mass) to be reduced.

The delivery system is deployable from an aircraft at approximately 40° to the airflow, so a stabilization parachute (see FIG. 3) is required to prevent tumbling and to orient the vehicle relative to the free air stream for reliable wing and fin deployment. A parachute assembly may be mated to the ADV fuselage through any suitable mechanism as would be known in the art. For example, a plurality of lines may form a connection between the parachute assembly and the fuselage, so that when the parachute is deployed, all parachute drag loads are carried by these lines in tension. When the release command is issued by the autopilot, a release mechanism is actuated by, for example, a burn-through resistor, causing release of the tension lines. The drag from the parachute pulls the entire parachute assembly aft, away from the fuselage, since the tension lines are no longer connected to the fuselage body.

The outer sleeve 22 is also attached to the parachute assembly. The sleeve prevents deployment of the spring-loaded wings and fins until it is removed. When the release mechanism is actuated, the parachute assembly slides aft and departs from the fuselage, and the sleeve is dragged aft with it. Once the sleeve is removed, the spring-loaded wings and fins deploy autonomously. Friction at the interface between the inner surface of the sleeve and the wings and fins is minimized to ensure that there are no obstructions to interfere with removal of the sleeve.

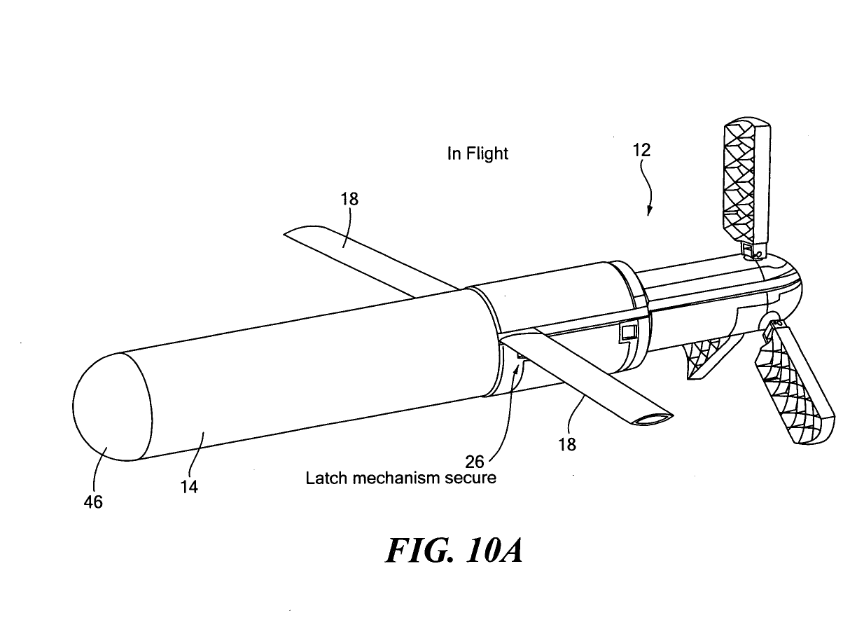

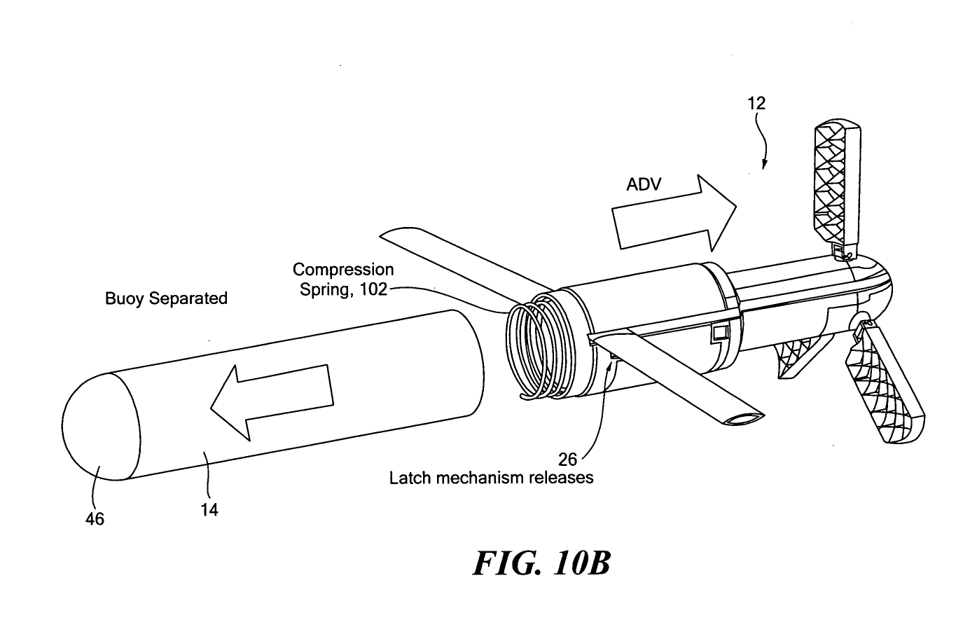

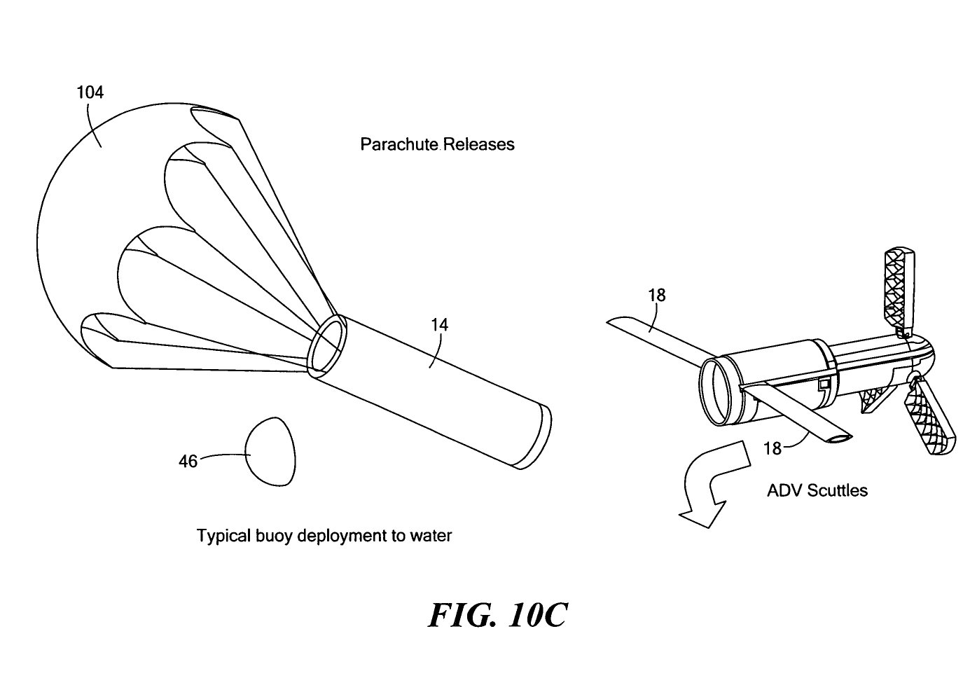

Release of the payload from the ADV is illustrated in FIGS. 10A-10C. Upon command from the autopilot, the release mechanism 26 releases a latch mechanism, decoupling the payload and the ADV. Any suitable releasable latch mechanism ay be provided. A biasing element 102, such as a compression spring, provides a separation force, pushing the payload away from the ADV and causing a relative acceleration and separation between the two airborne objects. The payload releases a parachute 104 stored in its nose.

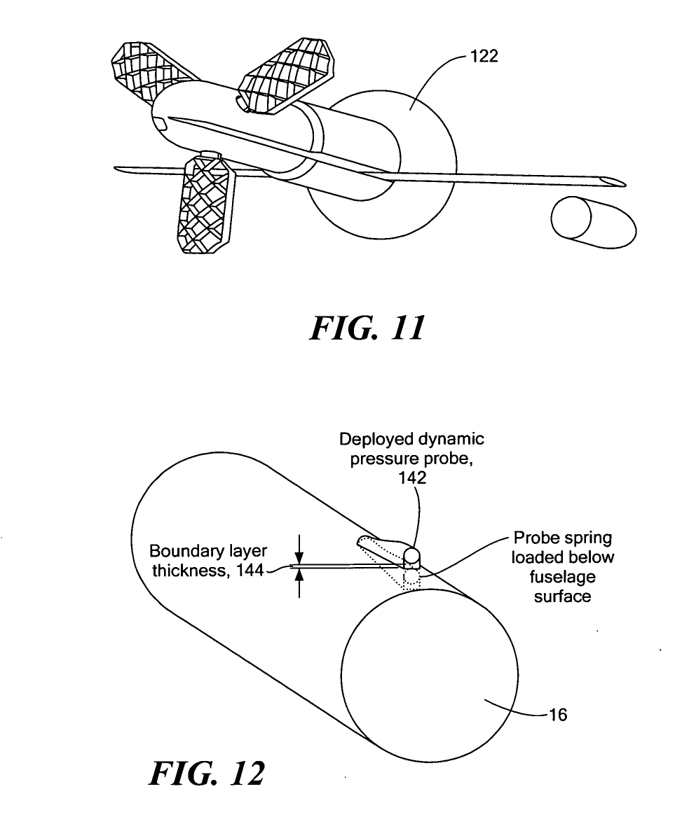

In a further embodiment, a deployable air bag 122 is contained in a cavity in the front end of the ADV. See FIG. 11. Upon initial inflation, pressure from the air bag causes deformation of a resilient latch mechanism. As it deforms, the latch mechanism decouples the ADV and the payload. Pressure from the expanding air bag provides a separation force between the payload and the ADV. The flexible nature of the air bag allows the pressure to be uniformly distributed across the entire face of the payload and the ADV.

The separation and ejection of the payload from the delivery vehicle in the last moments of flight must be clean. That is, the payload parachute must deploy properly, and the flight paths of the deployed payload and the remaining air delivery vehicle must not meet. Once the payload separates from the ADV, the center of gravity of the remaining vehicle, the ADV, moves far aft, causing the ADV to become unstable. Also, the air bag, if used, continues to inflate to full size (for example, approximately 15 inches in diameter). The inflated air bag forms a large, high drag decelerator at the front of the ADV, causing the ADV to further decelerate and further increase the separation from the payload. Additionally, the large decelerator at the front of the ADV further destabilizes it, causing it to enter a high drag tumble maneuver, causing still further deceleration and separation from the payload.

A flight control computer (autopilot), with onboard GPS, gyroscopes, and air data sensors, is mounted to the fuselage. The autopilot controls the flight path of the delivery vehicle and allows placement accuracy of the payload within 100 meters. The autopilot includes an onboard GPS receiver, 2-axis gyroscopes, 3-axis accelerometers, and static (altitude) and dynamic (airspeed) air pressure sensors. A GPS antenna is mounted to the upper fuselage. The autopilot controls the servos and relays, and can be programmed with a large number (e.g., 1000) waypoints. A suitable autopilot is the MP2028 miniature UAV Autopilot available from MicroPilot.

A dynamic pressure source is required to provide airspeed data to the autopilot. A nose location for a pressure probe is not suitable, as it would be blocked by the aerodynamic nose and would be physically removed from the air delivery vehicle. Therefore, a small, spring-loaded pressure probe 142 comprising a pitot tube is provided that depresses into the fuselage body in the stowed position. See FIG. 17. When the parachute sleeve is in place, the pressure probe cannot be deployed. When the sleeve is extracted during wing and fin deployment, the pitot tube pops out into the airstream. The fuselage location means that there is a finite thickness boundary layer 144 where the local airstream velocity is less than the free stream. Therefore, the pitot tube opening is located to protrude beyond the boundary layer 144, so that it sees all of the free stream dynamic pressure. A flexible plastic tube connects the dynamic probe to the dynamic pressure sensor located on the autopilot circuit board.

A static air pressure port is located to provide an air density signal to the autopilot. This port is flush mounted on the aft portion of the fuselage at a location that experiences minimal static pressure changes with the angle of attack and sideslip angle of the delivery system, as can be determined with wind tunnel testing depending on the application.

A power supply 152 is also mounted to the fuselage. The power supply is used primarily for the flight control actuators. The autopilot draws a relatively small current. A suitable power supply can be a silver-zinc or thermal battery, such as are used in missiles.

Between the time the delivery system is loaded in the launch chute and when it is stabilized in flight, the autopilot loses the GPS signal. Provisions are made to tell the autopilot how to control the vehicle attitude during this period of GPS loss. Upon launch, the autopilot accelerometers sense the axial shock load pulse from the CAD event. High G loads can create error in the GPS navigation/attitude solution. Therefore the software locks out the GPS sensor input to the navigation/attitude solution immediately after launch. Additionally, when the parachute deploys upon ejection of the delivery system from the launch tube, the system is pointed nose up at approximately 40° elevation from the launch tube angle. When the parachute deploys, it rapidly results in a nose down pitching moment that orients the longitudinal axis of the system with the local airflow, at approximately 0° elevation angle. This occurs quickly, in less than 100 milliseconds, which results in a pitch rate of 300° per second or more for that brief period. Piezo gyros on the autopilot may saturate at this pitch rate and provide an erroneous signal. Since pitch attitude is calculated by integrating pitch rate, an erroneous pitch rate signal can led to an erroneous pitch angle estimate, so code is provided to lock out the rate gyros during the launch phase.

The autopilot issues a parachute release command based on a timer initiated upon detection of the launch event, where the time is selected for the parachute trajectory to stabilize. The software then re-engages the accelerometers and rate gyros. An initial approximate orientation solution is derived from the 3 axis accelerometers sensing the 1 G downward gravity vector.

When used to delivery sonobuoys, the delivery system can be sized for launch from existing sonobuoy delivery chutes. For the U.S. Navy, sonobuoys are supplied in standard sizes, such as G 16.5 inches long), F (12 inches long), A/2 (18 inches long), and A (36 inches long). The air delivery vehicle can be sized cooperatively with a selected sonobuoy size to form a package that fits within the envelope of an A-size sonobuoy (36 inches long), allowing the delivery system to be launched from a delivery tube that fits A-size sonobuoys. Thus, using a 12-inch F-size sonobuoy, the air delivery vehicle can be 24 inches long. The smaller the sonobuoy, the longer the wing span of the air delivery vehicle and the greater the stand-off range.

It will be appreciated that the delivery system can be used for other applications, such as land-based sensor placement. The delivery system can be launched from launch systems other than sonobuoy launch systems. The invention is not to be limited by what has been particularly shown and described, except as indicated by the appended claims.

What is claimed is:

1. An aerial delivery system comprising:
An air delivery vehicle and a payload releasably attached to the air delivery vehicle;
the air delivery vehicle comprising a fuselage;
a pair of wings pivotably mounted to the fuselage for movement from a stowed position against the fuselage to a deployed position extending from the fuselage;
a plurality of tail fins pivotably mounted to the fuselage aft of the wings for movement from a stowed position against the fuselage to a deployed position extending from the fuselage; and
a release mechanism between the air delivery vehicle and the payload.

2. The system of claim 1, wherein the release mechanism comprises a biasing mechanism disposed between the air delivery vehicle and the payload.

3. The system of claim 2, wherein the biasing mechanism comprises a compression spring.

4. The system of claim 1, wherein the release mechanism comprises an air bag assembly disposed between the air delivery vehicle and the payload.

5. The system of claim 4, wherein the release mechanism further comprises a source of gas to inflate an air bag of the air bag assembly.

6. The system of claim 1, wherein the wings are stowed in slots in sides of the fuselage in the stowed position.

7. The system of claim 1, wherein the wings are stowed in slots along a center line of the fuselage in the stowed position.

8. The system of claim 1, wherein the wings are stowed in slots in the fuselage, one slot above a center line of the fuselage, another slot below the center line of the fuselage.

9. The system of claim 1, further comprising a wing deployment mechanism biased to move the wings to the deployed position.

10. The system of claim 1, wherein the wings have an airfoil profile.

11. The system of claim 1, wherein the tail fins are further pivotably mounted for rotation about an axis extending radially from the fuselage.

12. The system of claim 1, wherein the tail fins comprise lattice fins.

13. The system of claim 1, further comprising an actuation system to pivot the tail fins about their associated radially extending axes to effect pitch, yaw, and roll control of the air delivery vehicle during flight.

14. The system of claim 13, wherein the actuation system comprises an actuator associated with each tail fin and connected to the associated tail fin with a linkage mechanism.

15. The system of claim 1, further comprising an autopilot programmable to follow a predetermined flight plan.

16. The system of claim 15, wherein the autopilot further includes a global position system receiver.

17. The system of claim 1, wherein the autopilot further includes a dynamic air pressure sensor for determining air speed, wherein the dynamic air pressure sensor is in communication with a dynamic pressure probe disposed on a surface of the air delivery vehicle extendable beyond a boundary layer.
